(19) United States
(12) Patent Application Publication
(10) Pub. No.: US 2007/0170105 A1
(43) Pub. Date: Jul. 26, 2007

(54) Resource-recovering water-filtering system

(76) Inventor: Chin Pei-Hung, Wandan Township (TW)

Correspondence Address: BRUCE H. TROXELL, SUITE 1404, 5205 LEESBURG PIKE, FALLS CHURCH, VA, 22041, US

(21) Appl. No.: 11/338,666

(22) Filed: Jan. 25, 2006

(51) Int. Cl. B01D 35/02; B01D 36/02

(52) U.S. Cl. 210/314

(57) ABSTRACT

A resource-recovering water-filtering system which is connected with a-drainer of an air-conditioner or the like. The condensed water naturally produced by the air-conditioner during cooling procedure is drained out from the drainer. The resource-recovering water-filtering system serves to filter the condensed water to produce clean water for reuse.

### BACKGROUND OF THE INVENTION

The present invention is related to a resource-recovering water-filtering system, and more particularly to a resource-recovering water-filtering system which is capable of filtering the water produced and drained out by a cooling equipment to produce clean water for reuse.

It is a trend to recover limited resource of the earth, especially water resource. Various water-saving equipments have been developed for saving water resource. Many kinds of appliances such as air-conditioner, refrigerators, washing machines and driers will consume water or naturally produce condensed water which is drained out from the appliances. With air-conditioner exemplified, Patent Publication No. 6779358 entitled “water collection and dispensing machine” discloses a measure for collecting the water produced by a cooling equipment for reuse. However, it is necessary to equip such machine with a preceding compressor for collecting condensed water. The compressor will consume power. In addition, the machine as a whole has too big volume and complicated structure.

It is therefore tried by the applicant to provide a resource-recovering water-filtering system which is capable of recovering condensed water without consuming power to meet requirement of environmental protection.

### SUMMARY OF THE INVENTION

It is therefore a primary object of the present invention to provide a resource-recovering water-filtering system which is capable of filtering the water produced and drained out by a cooling equipment to produce clean water for reuse.

The present invention can be best understood through the following description and accompanying drawings wherein:

### BRIEF DESCRIPTION OF THE DRAWINGS

FIG. 1 is a flow cart of the operation of the resource-recovering water-filtering system of the present invention;

FIG. 2 is a perspective view showing the application of the resource-recovering water-filtering system of the present invention;

FIG. 3 is a sectional view showing that the filters of the resource-recovering water-filtering system of the present invention are serially connected; and

FIG. 4 is a sectional view of another embodiment of the resource-recovering water-filtering system of the present invention.

### DETAILED DESCRIPTION OF THE PREFERRED EMBODIMENTS

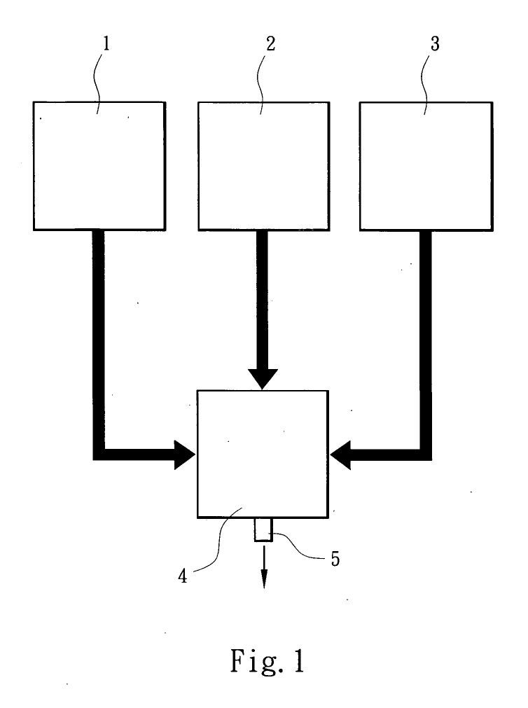

Please refer to FIG. 1. The resource-recovering water-filtering system 4 of the present invention is connected with a drainer of an air-conditioner 1, a car 2 or a cooling equipment 3. The water-filtering system 4 serves to filter the water or liquid produced by the air-conditioner 1 during cooling procedure. The clean water is drained out from the water outlet 5 for reuse.

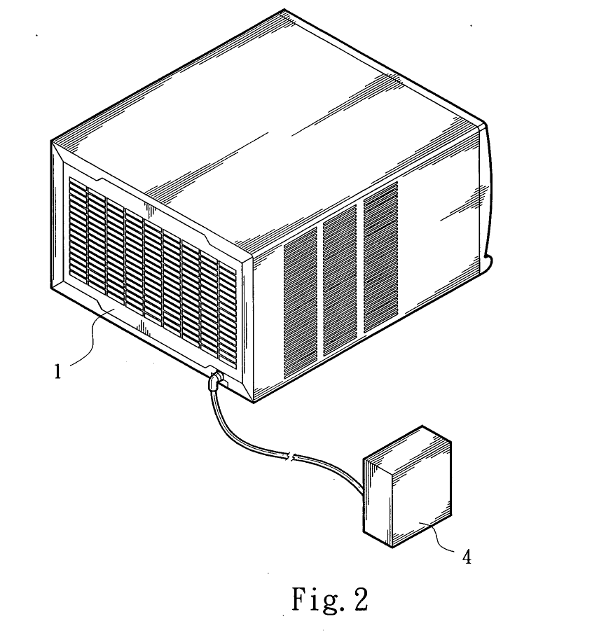

Referring to FIG. 2, the resource-recovering water-filtering system 4 of the present invention is connected with the drainer of the air-conditioner 1. The water-filtering system 4 serves to filter the water or liquid produced by the air-conditioner 1 during cooling procedure. The clean water is drained out from the water outlet 5 for reuse.

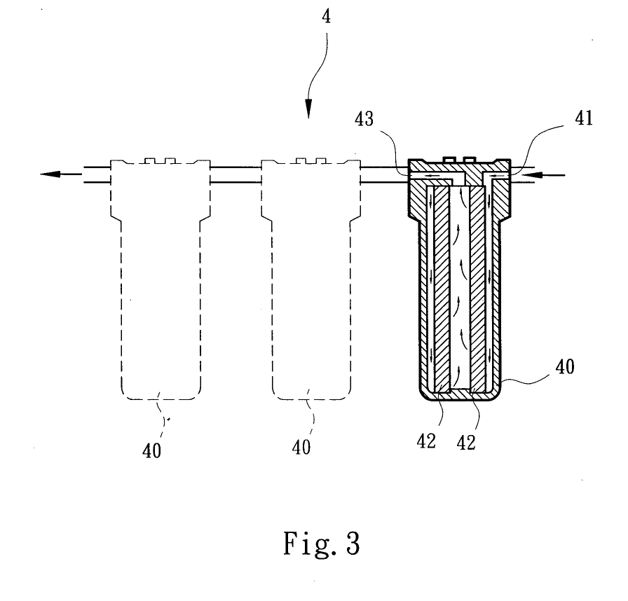

Referring to FIG. 3, the resource-recovering water-filtering system 4 of the present invention includes multiple filters 40which are serially connected. Each filter 40 has a water inlet 41 and a water outlet 43. The water goes into the filter 40 from the water inlet 41 and filters through the filter cartridges 42 disposed in the filter 40. Thereafter, the water is drained out from the water outlet 43. The filter cartridge 42 can be made of PP cotton filtering material, ceramic/porcelain filtering material, hollow silk membrane filtering material, fabric filtering material, pulp filtering material, membrane filtering material, activated carbon filtering material, resin filtering material or mineral filtering material. The filter 4 can be an ultraviolet filter, bacteria-separating filter or boiling water machine.

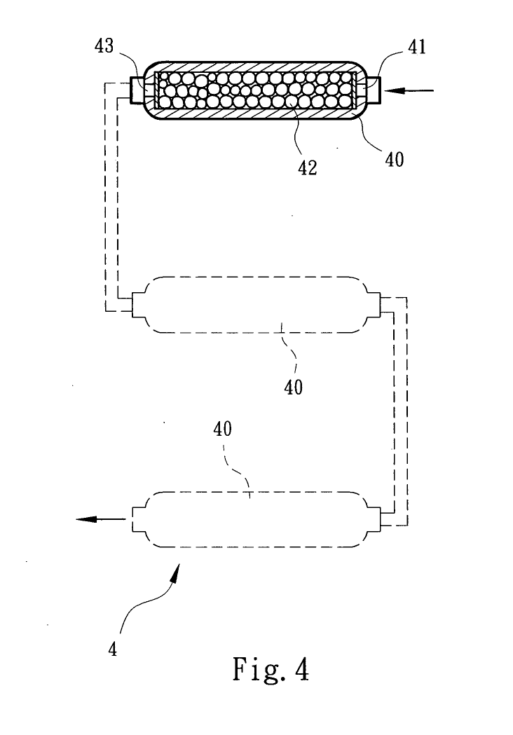

Alternatively, the resource-recovering water-filtering system 4 of the present invent ion includes multiple filters 40 which are serially connected as shown in FIG. 4. Only the housings of the filters 40 are different from the housings of the filters 40 of the first embodiment. Basically, each filter 40 still has a water inlet 41 and a water outlet 43. The water goes into the filter 40 from the water inlet 41 and filters through the filter cartridges 42 disposed in the filter 40. Thereafter, the water is drained out from the water outlet 43.

In conclusion, the resource-recovering water-filtering system 4 of the present invention has a simplified structure capable of recovering water for reuse of resource.

The above embodiments are only used to illustrate the present invention, not intended to limit the scope thereof. Many modifications of the above embodiments can be made without departing from the spirit of the present invention.

What is claimed is:

1. A resource-recovering water-filtering system which is connected with a drainer of an air-conditioner, the condensed water naturally produced by the air-conditioner during cooling procedure being drained out from the drainer, the resource-recovering water-filtering system serving to filter the condensed water to produce clean water for reuse.

2. The resource-recovering water-filtering system as claimed in claim 1, wherein the resource-recovering water-filtering system comprises multiple filters which are serially connected, each filter having a water inlet and a water outlet, multiple filter cartridges being disposed in the filter, whereby the water goes into the filter from the water inlet and filters through the filter cartridges and then the water is drained out from the water outlet.
